(19) United States
(12) Patent Application Publication
(10) Pub. No.: US 2019/0077197 A1
(43) Pub. Date: Mar. 14, 2019

(54) Pneumatic Tire, Having Working Layers Comprising Monofilaments And A Tire Tread With Grooves

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Aymeric BONNET, Clermont-Ferrand Cedex 9 (FR); Jacques MOREL-JEAN, Clermont-Ferrand Cedex 9 (FR); Jean-Charles DEROBERT-MAZURE, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/771,651

(22) PCT Filed: Oct. 26, 2016
(86) PCT No.: PCT/EP2016/075741

§ 371 Date: Apr. 27, 2018

(30) Foreign Application Priority Data
Oct. 27, 2015 (FR) 1560238

(51) Int. Cl. B60C 11/04; B60C 9/00; B60C 9/22

(52) U.S. Cl. CPC B60C 11/04; B60C 2009/2019; B60C 9/22; B60C 9/0064

(57) ABSTRACT

Two crossed tire working layers (41, 42), comprise mutually parallel reinforcing elements forming, with the circumferential direction (XX′) of the tire, an angle at least equal to 20° and at most equal to 50°. The reinforcing elements are made up of individual metal threads or monofilaments having a cross section at least equal to 0.20 mm and at most equal to 0.5 mm. The tire also comprises major grooves of a depth D at least equal to 5 mm and of a width W at least equal to 1 mm, axially exterior major grooves (26) opening inwardly into a circumferential groove (24) comprising at least one bridge of rubber (27) connecting the two main faces of the groove, the at least one bridge of rubber having a length LB at least equal to W and a height h at least equal to half the depth D of the groove.

### FIELD OF THE INVENTION

The present invention relates to a passenger vehicle tire, and more particularly to the crown of such a tire.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively.

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

A tire comprises a crown comprising a tread that is intended to come into contact with the ground via a tread surface, two beads that are intended to come into contact with a rim, and two sidewalls that connect the crown to the beads. Furthermore, a tire comprises a carcass reinforcement, comprising at least one carcass layer, radially on the inside of the crown and connecting the two beads.

The tread of a tire is delimited, in the radial direction, by two circumferential surfaces of which the radially outermost is referred to as the tread surface and of which the radially innermost is referred to as the tread pattern bottom surface. In addition, the tread of a tire is delimited, in the axial direction, by two lateral surfaces. The tread is also made up of one or more rubber compounds. The expression “rubber compound” refers to a composition of rubber comprising at least one elastomer and a filler.

The crown comprises at least one crown reinforcement radially on the inside of the tread, comprising at least one working reinforcement, made up of at least one working layer made up of mutually parallel reinforcing elements that form with the circumferential direction, an angle of between 15° and 50°. The crown reinforcement may also comprise at least one hooping layer radially on the outside of the working layers comprising reinforcing elements that form, with the circumferential direction, an angle of between 0° and 10°.

In order to obtain good grip on wet ground, cuts are made in the tread. A cut denotes either a well, or a groove, or a sipe, or a circumferential groove and forms a space opening onto the tread surface. On the tread surface, a well has no characteristic main dimension. A sipe or a groove has two characteristic main dimensions: a width W and a length Lo, such that the length Lo is at least equal to twice the width W. A sipe or a groove is therefore delimited by at least two lateral faces determining its length Lo and connected by a bottom face, the two lateral faces being distant from one another by a non-zero distance referred to as the width W of the sipe or of the groove.

By definition, a sipe or a groove which is delimited by:
only two main lateral faces is said to be open-ended,
by three lateral faces, two of them being main faces determining the length of the cut, is said to be blind,
by four lateral faces, two of them being main faces determining the length of the cut, is said to be double-blind.

The difference between a sipe and a groove is the value of the mean distance separating the two main lateral faces of the cut, namely its width W. In the case of a sipe, this distance is suitable for allowing the two mutually-facing main lateral faces to come into contact when the sipe enters the contact patch in which the tire is in contact with the road surface. In the case of a groove, the main lateral faces of this groove cannot come into contact with one another under usual running conditions. This distance for a sipe is generally, for passenger vehicle tires, at most equal to 1 millimetre (mm). A circumferential groove is a cut of substantially circumferential direction that is substantially continuous over the entire circumference of the tire.

More specifically, the width W is the mean distance, determined along the length of the cut and along a radial portion of the cut, comprised between a first circumferential surface, radially on the inside of the tread surface at a radial distance of 1 mm, and a second circumferential surface, radially on the outside of the bottom surface at a radial distance of 1 mm, so as to avoid any measurement problem associated with the junctions at which the two main lateral faces meet the tread surface and the bottom surface.

The depth of the cut is the maximum radial distance between the tread surface and the bottom of the cut. The maximum value of the depths of the cuts is referred to as the tread depth D. The tread pattern bottom surface, or bottom surface, is defined as being the surface of the tread surface translated radially inwards by a radial distance equal to the tread depth.

### PRIOR ART

In the current context of sustainable development, the saving of resources and therefore of raw materials is one of the industry's key objectives. For passenger vehicle tires, one of the avenues of research for achieving this objective is to replace the metal cords usually employed as reinforcing elements in various layers of the crown reinforcement with individual threads or monofilaments as described in document EP 0043563 in which this type of reinforcing element is used with the twofold objective of saving weight and lowering rolling resistance.

However, the use of this type of reinforcing element has the disadvantage of causing a problem of these monofilaments buckling under compression, causing the tire to exhibit insufficient endurance, as described in document EP2537686. As that same document describes, a person skilled in the art proposes a particular layout of the various layers of the crown reinforcement and a specific quality of the materials that make up the reinforcing elements of the crown reinforcement in order to solve this problem.

An analysis of the physical phenomenon shows that the buckling of the monofilaments occurs in the axially outermost parts of the tread underneath the grooves, as mentioned in document JP 2012071791. This region of the tire has the particular feature of being subjected to high compression loadings when the vehicle is running in a curved line. The resistance of the monofilaments to buckling is dependent on the geometry of the grooves, thus demonstrating the surprising influence that the tread pattern has on the endurance of the monofilaments.

### SUMMARY OF THE INVENTION

The key objective of the present invention is therefore to increase the endurance of a tire the working layer reinforcing elements of which are made up of monofilaments, through the design of a suitable tread pattern for the tread.

This objective is achieved by a passenger vehicle tire comprising:
a tread intended to come into contact with the ground via a tread surface and having an axial width LT,
the tread comprising two axially exterior portions each having an axial width (LS1, LS2) at most equal to 0.3 times the axial width LT,
at least one axially exterior portion comprising at least one longitudinal groove, and axially exterior grooves, an axially exterior groove forming a space opening onto the tread surface and being delimited by at least two faces referred to as main lateral faces connected by a bottom face, of which grooves at least one opens internally, forming a space which likewise opens into the circumferential groove,
at least one axially exterior groove, referred to as major groove, having a width W, defined by the distance between their two main lateral faces, at least equal to 1 mm, a depth D, defined by the maximum radial distance between the tread surface and the bottom face, at least equal to 5 mm,
The tire further comprising a crown reinforcement radially on the inside of the tread,
the crown reinforcement comprising a working reinforcement and a hoop reinforcement,
the working reinforcement comprising at least two working layers each comprising reinforcing elements which are coated in an elastomeric material, mutually parallel and respectively form, with a circumferential direction (XX′) of the tire, an oriented angle (A1, A2) at least equal to 20° and at most equal to 50°, in terms of absolute value, and of opposite sign from one layer to the next,
the said reinforcing elements in each working layer being made up of individual metal threads or monofilaments having a cross section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm,
the hoop reinforcement comprising at least one hooping layer comprising reinforcing elements which are mutually parallel and form, with the circumferential direction (XX′) of the tire, an angle at most equal to 10⁰, in terms of absolute value,
an axially exterior and inwardly opening major groove of the tread comprising at least one bridge of rubber connecting the two main faces of the groove and the at least one bridge of rubber having a cumulative length LB at least equal to the width W of the groove and a radial height h at least equal to half the depth D of the groove,
the breaking strength R_{C} of each working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

For grooves of complex shape, what is meant by the width of the groove is the mean distance between the main lateral faces, averaged over the curved length of the the groove.

From a mechanical operation standpoint, the buckling of a reinforcing element occurs in compression. It occurs only radially on the inside of the axially outermost portions of the tread because it is in this zone that the compressive loadings are highest in the event of transverse loading. These portions each have as their maximum axial width 0.3 times the total width of the tread of the tire.

Buckling is a complex and unstable phenomenon which leads to fatigue rupture of an object that has at least one dimension one order of magnitude smaller than a main dimension, such as beams or shells. Monofilaments are objects of this type with a cross section very much smaller than their length. The phenomenon begins when the main dimension is compressed. It continues because of the asymmetry of geometry of the monofilament, or because of the existence of a transverse force caused by the bending of the monofilament, which is a stress loading that is highly destructive for metallic materials. This complex phenomenon is notably highly dependent on the boundary conditions, on the mobility of the element, on the direction of the applied load and on the deformation resulting from this load.

In addition, the buckling of the monofilaments of the working layers occurs only under the axially exterior grooves of the tread because in the absence of an axially exterior groove, the rubber material of the tread radially on the outside of the reinforcing element absorbs most of the compressive load. Likewise, the axially exterior grooves the depth of which is less than 5 mm, have no influence on the buckling of the monofilaments. Therefore, only the axially exterior grooves referred to as major grooves need to be subjected to special design rules when using monofilaments in the working layers. These axially exterior major grooves are particularly essential to the wet grip performance of the tire.

Moreover, the axially exterior grooves the width of which is less than 1 mm, referred to as sipes, close when they enter the contact patch and therefore protect the monofilaments from buckling. In the case of the grooves that are not axially exterior, the compressive loading in the case of transverse loading of the tire is too low to cause buckling. Moreover, it is common practice in passenger vehicle tires for only sipes of a width less than 1 mm to be arranged in the axially central parts of the tread.

In directions in which no empty space allows for movement, the compressive loadings will be absorbed by the rubber compound. When an axially exterior major groove is present, this groove does not absorb the load, but rather allows movements in compression in the direction perpendicular to the mean direction of the main lateral faces. In the case of a tread in which substantially circumferential grooves are arranged in order to obtain wet grip performance, it is common practice for the axially exterior grooves to open into those grooves in order to constitute a water storage reserve. Furthermore, it is common practice to make the grooves that open internally open externally also, so that they allow removal to the outside of water situated under the contact patch. In these two instances, the geometry of the major grooves encourages the placing under compression of the monofilaments of the working layers.

In order to avoid introducing this compression, the solution proposed by the inventors is to position, in the inwardly-opening axially exterior major grooves, at least one bridge of rubber having a cumulative mean length LB at least equal to the width W of the groove and a height h at least equal to half the depth D of the groove.

The height of the bridge of rubber is the distance between the bottom surface of the groove and the radially outermost point of the bridge of rubber. The length of a bridge of rubber is the curved length of the main faces of the groove along which the bridge of rubber is present. In the event of there being a difference between the curved lengths on the two main faces of the groove, the length of the bridge of rubber will be equal to the mean of the lengths. If one of the edge corners of the bridge of rubber is chamfered, then the length of the bridge of rubber will be evaluated using a mean calculated over its height. The length is said to be cumulative because in the case of multiple bridges of rubber, the lengths of the various bridges of rubber will be summed in order to obtain the cumulative total length which needs to be at least equal to W in order for the bridge of rubber not to have itself a main dimension in the direction allowing compression of the monofilaments of the working layers. From a mechanical standpoint, a plurality of bridges of rubber is more effective than a single bridge of rubber of the same cumulative length. Likewise, to afford the monofilaments effective protection, the radial height h of the bridge of rubber needs to be at least equal to half the depth D of the groove. In the event of multiple bridges of rubber, all the heights of the various bridges of rubber need to be at least equal to half the depth D of the groove.

The monofilaments may have any cross-sectional shape, in the knowledge that oblong cross sections represent an advantage over circular cross sections, even when of smaller size, because their second moment of area in bending and, therefore, their resistance to buckling, are higher. In the case of a circular cross section, the smallest dimension corresponds to the diameter of the cross section. In order to guarantee the fatigue breaking strength of the monofilaments and the resistance to shearing of the rubber compounds situated between the filaments, the density of reinforcing elements of each working layer is at least equal to 100 threads per dm and at most equal to 200 threads per dm. What is meant by the density is the mean number of monofilaments over a 10-cm width of the working layer, this width being measured perpendicularly to the direction of the monofilaments in the working layer considered. The distance between consecutive reinforcing elements may be fixed or variable. The reinforcing elements may be laid during manufacture either in layers, in strips, or individually.

Furthermore, the resistance of a monofilament to buckling is also dependent on the resistance of the axially adjacent filaments, the onset of buckling in one being able to lead to the buckling of another through the effect of a distribution of load around the monofilament that is buckling. In order to obtain improved endurance performance, it is appropriate not only to observe monofilament density and diameter conditions but also to satisfy a condition relating to the strength of the working layer, namely the breaking strength R_{C} of each working layer which needs to be at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

For a tire for which no specific direction of mounting is imposed, the solution involves applying the invention to the two axially outermost portions of the tread.

For a tire for which a specific direction of mounting is imposed, one option is to apply the invention to only that axially outermost portion of the tread that is situated on the outboard side of the vehicle.

The tread patterns of passenger vehicle tires are usually either substantially symmetric or substantially antisymmetric, or substantially asymmetric.

It is advantageous for any axially exterior major groove to have a width W at most equal to 10 mm so as to limit the void volume of the tread and preserve the wearability of the tire.

For preference, the axially exterior major grooves have a depth D at most equal to 8 mm. This is because beyond a certain thickness of rubber, the tread becomes too flexible and the tire loses performance in terms of wear, behaviour and rolling resistance.

It is particularly advantageous for an axially exterior major groove to open axially onto the outside of the tread so as to enable the tire to remove the water to the outside of the contact patch when running so as to ensure good grip performance on wet road surfaces and thus avoid the phenomenon of aquaplaning.

For preference, the axially exterior major grooves are spaced apart, in the circumferential direction (XX′) of the tire, by a circumferential spacing P at least equal to 8 mm, in order to avoid excessive flexibility of the tread pattern and loss of wearing and rolling-resistance performance. The circumferential spacing is the mean circumferential distance, over the relevant axially outermost part of the tread, between two lateral faces of two circumferentially consecutive axially exterior grooves. Usually, the treads of tires may have spacings that are variable notably so as to limit road noise.

One preferred solution likewise consists in the axially exterior major grooves being spaced apart, in the circumferential direction (XX′) of the tire, by a circumferential spacing P at most equal to 50 mm, in order to guarantee, by having a sufficient tread void volume ratio, that the tire is able to grip on wet road surfaces.

It is particularly advantageous for the bottom face of an inwardly-opening axially exterior major groove to be positioned radially on the outside of the crown reinforcement at a radial distance D1 at least equal to 1.5 mm. This is because this minimal quantity of rubbery material protects the crown from attack and puncturing by obstacles, stones, or any debris lying on the ground.

It is preferable for the bottom face of an axially exterior major groove to be positional radially on the outside of the crown reinforcement at a radial distance D1 at most equal to 3.5 mm in order to obtain a tire that performs well in terms of rolling resistance.

For preference, at least one bridge of rubber of an inwardly-opening axially exterior major groove, having a width Wmin at least equal to 1.5 mm, comprises at least one sipe having a width W1 most equal to 1 mm and a depth h1 at least equal to h/2 and at most equal to h, h being the radial height of the bridge of rubber. Now, the bridge of rubber protects the monofilaments of the working reinforcement by working in compression, but its presence increases the energy needed to flatten the tire, so has a negative effect on rolling resistance. One solution to this problem is to make in the bridge of rubber a sipe of small thickness W1, which only slightly alters its compression behaviour and makes it easier for the tire to flatten.

Since a bridge of rubber of an inwardly-opening axially exterior groove has an axially exterior edge corner, one preferred solution is for the axially exterior edge corner of the bridge of rubber to be chamfered so as to make it easier for water to flow on a wet road surface.

It is advantageous for at least an axially exterior portion, comprising axially exterior major grooves, to comprise sipes having a width W2 at most equal to 1 mm. In order to improve grip on certain types of ground, notably on ground covered with black ice or snow, it is possible to provide small-width sipes in the axially exterior portions of the tread without impairing the endurance of the tire the working reinforcement of which contains monofilaments. This is because when these sipes enter the contact patch, their lateral faces come into contact and the rubbery material of the tread then absorbs the compressive loadings. These sipes may have widths that are variable in their main directions or in their depth as long as their minimum width is at most equal to 1 mm over a sufficient surface area at least equal to 50 mm².

It is also possible to provide grooves of small depth, smaller than 5 mm, without significantly impairing the endurance of the tire, although, in this case, the performance, notably the wet grip performance, becomes degraded as the tire wears.

Advantageously, the two axially exterior portions of the tread each have an axial width (LS1, LS2) at most equal to 0.2 times the axial width LT of the tread.

For preference, each working layer comprises reinforcing elements made up of individual metal threads or monofilaments having a cross section the smallest dimension of which is at least equal to 0.3 mm and at most equal to 0.37 mm, which constitute an optimum for balancing the target performance aspects: weight saving and buckling endurance of the reinforcing elements of the working layers.

One preferred solution is for each working layer to comprise reinforcing elements which form, with the circumferential direction (XX′) of the tire, an angle the absolute value of which is at least equal to 22° and at most equal to 35°, which constitute an optimal compromise between tire behaviour and tire endurance performance.

It is advantageous for the density of reinforcing elements in each working layer to be at least equal to 120 threads per dm and at most equal to 180 threads per dm in order to guarantee improved endurance of the rubber compounds working in shear between the reinforcing elements and the tension and compression endurance thereof.

The reinforcing elements of the working layers may or may not be rectilinear. They may be preformed, of sinusoidal, zigzag, or wavy shape, or following a spiral. The reinforcing elements of the working layers are made of steel, preferably carbon steel such as those used in cords of the “steel cords” type, although it is of course possible to use other steels, for example stainless steels, or other alloys.

When a carbon steel is used, its carbon content (% by weight of steel) is preferably comprised in a range from 0.8% to 1.2%. The invention is particularly applicable to steels of the very high strength “SHT” (“Super High Tensile”), ultra-high strength “UHT” (“Ultra High Tensile”) or “MT” (“Mega Tensile”) steel cord type. The carbon steel reinforcers then have a tensile breaking strength (Rm) preferably higher than 3000 MPa, more preferably higher than 3500 MPa. Their total elongation at break (At), which is the sum of the elastic elongation and the plastic elongation, is preferably greater than 2.0%.

As far as the steel reinforcers are concerned, the measurements of breaking strength, denoted Rm (in MPa), and elongation at break, denoted At (total elongation in %), are taken under tension in accordance with ISO standard 6892 of 1984.

The steel used, whether it is in particular a carbon steel or a stainless steel, may itself be coated with a layer of metal which improves for example the workability of the steel monofilament or the wear properties of the reinforcer and/or of the tire themselves, such as properties of adhesion, corrosion resistance or even resistance to ageing. According to one preferred embodiment, the steel used is covered with a layer of brass (Zn—Cu alloy) or of zinc; it will be recalled that, during the process of manufacturing the wire threads, the brass or zinc coating makes the wire easier to draw, and makes the wire thread adhere to the rubber better. However, the reinforcers could be covered with a thin layer of metal other than brass or zinc, having for example the function of improving the corrosion resistance of these threads and/or their adhesion to the rubber, for example a thin layer of Co, Ni, Al, of an alloy of two or more of the Cu, Zn, Al, Ni, Co, Sn compounds.

For preference, the reinforcing elements of the at least one hooping layer are made of textile of aliphatic polyamide, aromatic polyamide or combination of aliphatic polyamide and of aromatic polyamide, polyethylene terephthalate or rayon type, because textile materials are particularly well-suited to this type of use because of their low mass and high rigidity. The distance between consecutive reinforcing elements in the hooping layer may be fixed or variable. The reinforcing elements may be laid during manufacture either in layers, in strips, or individually.

It is advantageous for the hoop reinforcement to be radially on the outside of the working reinforcement in order to ensure good endurance of the latter.

### BRIEF DESCRIPTION OF THE DRAWINGS

The features and other advantages of the invention will be understood better with the aid of FIGS. 1 to 6, the said figures being drawn not to scale but in a simplified manner so as to make it easier to understand the invention:

FIG. 1 is a perspective view depicting part of the tire according to the invention, particularly its architecture and its tread.

FIG. 2 depicts a meridian section through the crown and illustrates the axially exterior parts 22 and 23 of the tread, and the width thereof.

FIGS. 3A and 3B depict two types of radially exterior meridian profile of the tread of a passenger vehicle tire.

FIGS. 4a, 4b illustrate various types of single or multiple bridges of rubber.

FIGS. 5a, 5b, 5c illustrate a method for determining the major grooves in the case of a network of grooves.

FIG. 6 illustrates the terms “interior edge” and “exterior edge” of a tread.

### DETAILED DESCRIPTION OF THE DRAWINGS

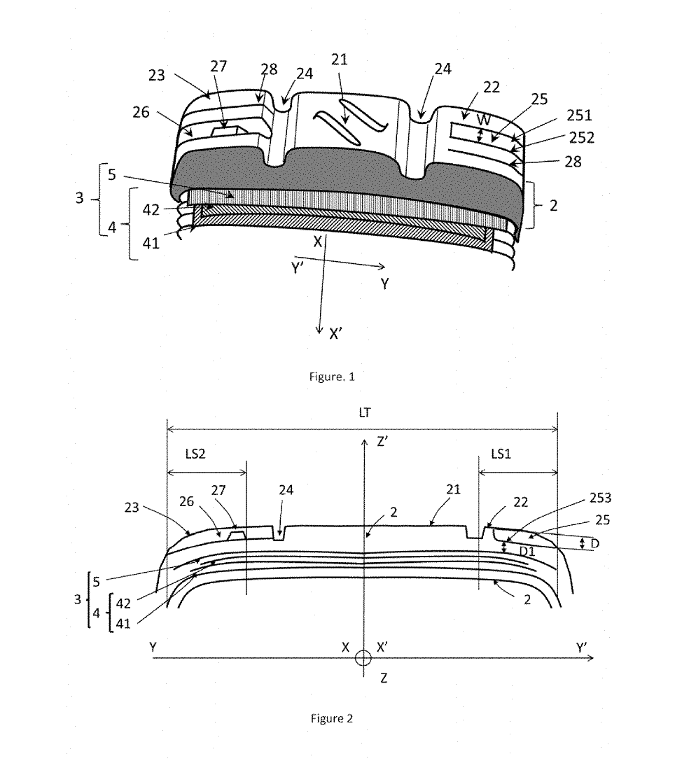

FIG. 1 depicts of part of the crown of a tire. The tire comprises a tread 2 which is intended to come into contact with the ground via a tread surface 21. In the axially exterior parts 22 and 23 of the tread there are circumferential grooves 24 and axially exterior major grooves 25 and 26 of width W and including one 26 which opens axially internally 26. That groove 26 comprises a bridge of rubber 27. The tread also comprises sipes 28 having a width W2 at most equal to 1 mm. The tire further comprises a crown reinforcement 3 comprising a working reinforcement 4 and a hoop reinforcement 5. The working reinforcement comprises two working layers 41 and 42 41 and 42 each comprising reinforcing elements which are mutually parallel and respectively form, with a circumferential direction (XX′) of the tire, an oriented angle at least equal to 20° and at most equal to 50°, in terms of absolute value, and of opposite sign from one layer to the next.

FIG. 1 depicts in the axially exterior parts 22 and 23 of the tread, only axially exterior grooves that are axial, following the axial axis (YY′). In reality, this depiction is pure convenience for the sake of the readability of FIG. 1, it being possible, depending on the performance aims, particularly in terms of wet grip, for the axially exterior grooves in the treads of passenger vehicles to make with the axial direction (YY′) an angle of between plus and minus 60°.

Furthermore, the sensitivity of the monofilaments of the working layers to buckling is dependent on the relative angles between the axially exterior grooves and the monofilaments. The relative angles between the axially exterior grooves and the monofilaments which are most penalising for this performance aspect are equal to 90°. Knowing that the angles made by the monofilaments with the circumferential axis is comprised between 20° and 50°, the angles made by the axially exterior grooves with respect to the transverse axis (YY′) for which the invention is most effective, is comprised between 20° and 50° modulo pi. However, the invention also makes it possible to improve the performance in terms of the endurance of the monofilaments to buckling, when the grooves are axial.

FIG. 2 is a schematic meridian section through the crown of the tire according to the invention. It illustrates in particular the widths LS1 and LS2 of the axially exterior portions 22 and 23 of the tread, and the total width of the tire LT. The longitudinal groove 24, the depth D of an axially exterior groove 25, 26, and the distance D1 between the bottom face 253 of any groove 25, 26 and the crown reinforcement 3, measured along a meridian section of the tire, are also depicted. FIG. 2 also illustrates a bridge of rubber 27 as well as the crown reinforcement 3. A meridian section of the tire is obtained by cutting the tire on two meridian planes. By way of example, a meridian section of tire has a thickness in the circumferential direction of around 60 mm at the tread. The measurement is taken with the distance between the two beads being kept identical to that of the tire mounted on its rim and lightly inflated.

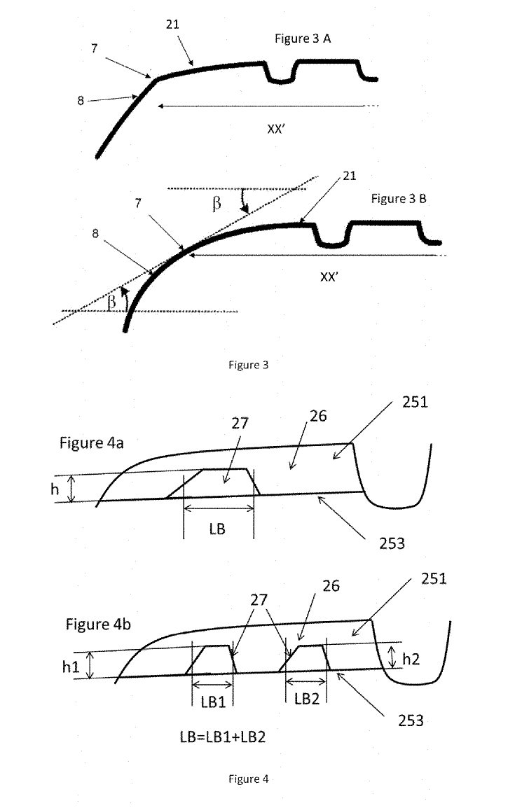

In FIGS. 3A and 3B, the axial edges 7 of the tread, that make it possible to measure the tread width, are determined. In FIG. 3A, in which the tread surface 21 is secant with the exterior axial surface of the tire 8, the axial edge 7 is determined by a person skilled in the art in a trivial way. In FIG. 3B, in which the tread surface 21 is continuous with the exterior axial surface of the tire 8, the tangent to the tread surface at any point on the said tread surface in the region of transition towards the sidewall is plotted on a meridian section of the tire. The first axial edge 7 is the point for which the angle β between the said tangent and an axial direction is equal to 30°. When there are several points for which the angle β between the said tangent YY′ and an axial direction YY′ is equal to 30°, it is the radially outermost point that is adopted. The same approach is used to determine the second axial edge of the tread.

FIGS. 4a and 4b schematically depict inwardly-opening axially exterior major grooves 26 of a tread 2 which grooves are equipped with bridges of rubber. FIG. 4a illustrates the case of a chamfered single bridge of rubber with radial height h and mean length LB. FIG. 4b illustrates the case of multiple bridges of rubber, with radial heights h1 and h2 at least equal to half the depth D and with cumulative mean length LB equal to the sum of the mean lengths of the various bridges of rubber.

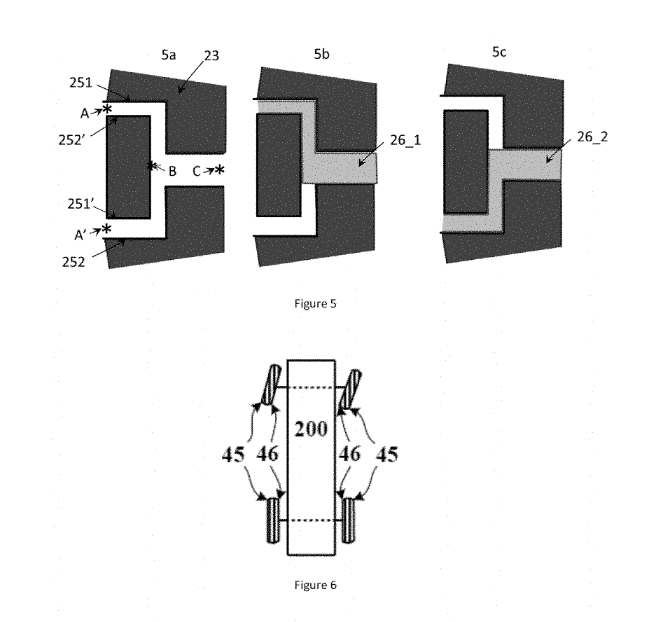

FIGS. 5a, 5b, 5c illustrate a method for determining the major grooves in the case of a network of grooves. For certain tread patterns, grooves open into other grooves as illustrated in FIG. 5a. In that case, the lateral faces of the network which are the continuous lateral faces most circumferentially distant from one another in the network of grooves will be determined, which in the present case, are the lateral faces 251 and 252. The invention will be applied to all the grooves which, as their lateral faces, have one of the lateral faces of the network and the directly adjacent opposite lateral face. Let us therefore consider here the groove 26_1 (FIG. 5b) made up of the lateral face of the network 251 and the opposite lateral face directly adjacent to 251, 252′, over a first section leading from point A to point B, and of the lateral face of the network 251 and the opposite lateral face 252 directly adjacent to 251, over a second portion leading from point B to point C. Next, consider the groove 26_2 (FIG. 5c) made up of the lateral face of the network 252 and the opposite lateral face 251′ directly adjacent to 252, over a first section leading from point A to point B, and the opposite lateral face 251 directly adjacent to 252, over a second portion leading from point B to point C. For more complex networks, this rule will be generalized so that all of the possible major grooves of the network substantially following the orientation of the lateral faces of the network satisfy the characteristics of the invention.

FIG. 6 schematically depicts tires mounted on mounting rims of wheels of a vehicle 200 and having a predetermined direction of mounting on the vehicle. Each tire comprises an exterior axial edge 45 and an interior axial edge 46, the interior axial edge 46 being the edge mounted on the bodyshell side of the vehicle when the tire is mounted on the vehicle in the said predetermined direction of mounting, and the exterior axial edge 45 being the opposite of that. In the document “outboard side of the vehicle” denotes the exterior axial edge 45.

The inventors have performed calculations on the basis of the invention for a tire of size 205/55 R16, inflated to a pressure of 2 bar, comprising two working layers comprising steel monofilaments of diameter 0.3 mm, distributed at a density of 158 threads to the dm and forming, with the circumferential direction, angles A1 and A2 equal respectively to 27° and −27°. The monofilaments have a breaking strength Rₘ equal to 3500 MPa and the working layers each have a breaking strength R_{c} equal to 39 000 N/dm. The tire comprises a circumferential groove 45 mm from the edge of the contact patch and inwardly-opening and outwardly-opening axially exterior major grooves of depth D equal to 7 mm and of width W equal to 5 mm, with a circumferential spacing of 30 mm. The radial distance D1 between the bottom face of the axially exterior grooves and the crown reinforcement is at least equal to 2 mm.

Two tires were calculated, a first A without a bridge of rubber and a second B equipped with a bridge of rubber of radial height h of 5.5 mm and of a mean length of 7 mm. The conditions used for the calculation reproduce the running conditions of a front tire on the outside of the bend, namely the tire that is most heavily loaded in a passenger vehicle. These loadings for a lateral acceleration of 0.7 g are as follows: a load (Fz) of 710 daN, a lateral load (Fy) of 505 daN and a camber angle of 3.0°. The presence of the bridge of rubber makes it possible to reduce the bending stresses in the monofilaments of the working reinforcement by 17%, which stresses are what cause them to break through fatigue loading.

The inventors produced two tires A and B of the size 205/55 R16, corresponding to the tires evaluated in the calculation. These two tires, inflated to a pressure of 2 bar, subjected to a load (Fz) of 749 daN, a lateral load (Fy) of 509 daN and a camber angle of 3.12°, were tested in rolling-road running, on an 8.5 m drum. Running was paused regularly for nondestructive measurement in order to check for breakage of the reinforcing elements in the working layers. In line with the calculation, breakages in the working layers of tire A appear after a distance 18% lower than for tire B.

1. A tire for a passenger vehicle, comprising:
a tread adapted to come into contact with the ground via a tread surface and having an axial width LT,
the tread comprising two axially exterior portions each having an axial width at most equal to 0.3 times the axial width LT,
at least one axially exterior portion comprising at least one circumferential groove, and axially exterior grooves, an axially exterior groove forming a space opening onto the tread surface and being delimited by at least two faces referred to as main lateral faces main lateral faces connected by a bottom face, of which grooves at least one opens internally, forming a space which likewise opens into the circumferential groove,
at least one said axially exterior groove, referred to as major groove, having a width W, defined by the distance between their two main lateral faces, at least equal to 1 mm, a depth D defined by the maximum radial distance between the tread surface and the bottom face, at least equal to 5 mm,
the tire further comprising a crown reinforcement radially on the inside of the tread,
the crown reinforcement comprising a working reinforcement and a hoop reinforcement,
the working reinforcement comprising at least two working layers each comprising reinforcing elements which are coated in an elastomeric material, mutually parallel and respectively form, with a circumferential direction of the tire, an oriented angle at least equal to 20° and at most equal to 50°, in terms of absolute value, and of opposite sign from one layer to the next,
said reinforcing elements in each working layer being comprised of individual metal threads or monofilaments having a cross section the smallest dimension of which is at least equal to 0.20 mm and at most equal to 0.5 mm, and a breaking strength Rm,
the density of reinforcing elements in each working layer being at least equal to 100 threads per dm and at most equal to 200 threads per dm,
the hoop reinforcement comprising at least one hooping layer comprising reinforcing elements which are mutually parallel and form, with the circumferential direction of the tire, an angle B at most equal to 10°, in terms of absolute value,
wherein an axially exterior and inwardly opening major groove of the tread comprises at least one bridge of rubber connecting the two main faces of the groove,
wherein the at least one bridge of rubber has a cumulative length LB at least equal to the width W of the groove and a radial height h at least equal to half the depth D of the groove,
and wherein the breaking strength R_{C} of each said working layer is at least equal to 30 000 N/dm, Rc being defined by: Rc=Rm*S*d, where Rm is the tensile breaking strength of the monofilaments in MPa, S is the cross-sectional area of the monofilaments in mm² and d is the density of monofilaments in the working layer considered, in number of monofilaments per dm.

2. The tire according to claim 1, wherein any axially exterior major groove has a width W at most equal to 10 mm.

3. The tire according to claim 1, wherein any said axially exterior major groove has a depth D at most equal to 8 mm.

4. The tire according to claim 1, wherein a said axially exterior major groove opens axially to the outside of the tread.

5. The tire according to claim 1, wherein the axially exterior major grooves are spaced apart, in the circumferential direction of the tire, by a circumferential spacing P at least equal to 8 mm.

6. The tire according to claim 1, wherein the axially exterior major grooves are spaced apart, in the circumferential direction of the tire, by a circumferential spacing P at most equal to 50 mm.

7. The tire according to claim 1, wherein the bottom face of an inwardly-opening axially exterior major groove is positioned radially on the outside of the crown reinforcement at a radial distance D1 at least equal to 1.5 mm.

8. The tire according to claim 1, wherein the bottom face of an inwardly-opening axially exterior major groove is positioned radially on the outside of the crown reinforcement at a radial distance D1 at most equal to 3.5 mm.

9. The tire according to claim 1, wherein at least one bridge of rubber of an inwardly-opening axially exterior major groove, having a width Wmin at least equal to 1.5 mm, comprises at least one sipe having a width W1 most equal to 1 mm and a depth h1 at least equal to h/2 and at most equal to h, h being the radial height of the bridge of rubber.

10. The tire according to claim 1, a bridge of rubber of an inwardly-opening axially exterior groove having an axially exterior edge corner, wherein the axially exterior edge corner of the bridge of rubber is chamfered.

11. The tire according to claim 1, wherein at least an axially exterior portion, comprising axially exterior major grooves, comprises sipes having a width W2 at most equal to 1 mm.

12. The tire according to claim 1, wherein the two axially exterior portions each have an axial width at most equal to 0.2 times the axial width LT.

13. The tire according to claim 1, wherein each said working layer comprises reinforcing elements comprised of individual metal threads or monofilaments having a diameter at least equal to 0.3 mm and at most equal to 0.37 mm.

14. The tire according to claim 1, wherein each said working layer comprises reinforcing elements which form, with the circumferential direction of the tire, an angle the absolute value of which is at least equal to 22° and at most equal to 35°.

15. The tire according to claim 1, wherein the density of reinforcing elements in each said working layer is at least equal to 120 threads per dm and at most equal to 180 threads per dm.

16. The tire according to claim 1, wherein the reinforcing elements of the working layers are made of steel.

17. The tire according to claim 1, wherein the reinforcing elements of the at least one hooping layer are made of textile, aromatic polyamide or combination of aliphatic polyamide and of aromatic polyamide, polyethylene terephthalate or rayon type.

18. The tire according to claim 1, wherein the hoop reinforcement is radially on the outside of the working reinforcement.

19. The tire according to claim 16, wherein the steel is carbon steel.

20. The tire according to claim 17, wherein the textile is of aliphatic polyamide.
